(19) United States
(12) Patent Application Publication
(10) Pub. No.: US 2017/0109669 A1
(43) Pub. Date: Apr. 20, 2017

(54) FIRST RESPONDER INTERFACE FOR EMERGENCY CONTROL

(71) Applicant: OTIS ELEVATOR COMPANY, Farmington, CT (US)

(72) Inventors: Arthur Hsu, South Glastonbury, CT (US); Ritesh Khire, South Windsor, CT (US)

(21) Appl. No.: 15/314,589

(22) PCT Filed: May 29, 2015
(86) PCT No.: PCT/US2015/033172

§ 371 Date: Nov. 29, 2016

Related U.S. Application Data
(60) Provisional application No. 62/005,458, filed on May 30, 2014.

(51) Int. Cl. G06Q 10/06

(52) U.S. Cl. CPC G06Q 10/0631

(57) ABSTRACT

A method for monitoring an area includes distributing, by a detector unit, light during a first instance of time in order to characterize the area based on first data associated with the first instance of time; distributing, by the detector unit, light during at least a second instance of time in order to obtain second data; comparing a first portion of the second data to at least one of: a second portion of the second data and the first data; and based on the comparison, signaling an alarm condition by the detector unit when an evolution in the second data is detected in an amount greater than a threshold.

### BACKGROUND

Exemplary embodiments of the present disclosure relate to evacuation of a building and, more particularly, to an interactive system to be used by first responders for efficiently responding to an event in a building.

During a building emergency event, first responders rapidly assess the threat or situation before making any decisions about evacuation and threat mitigation. This assessment typically takes valuable time and is often made with very limited information, especially in tall buildings.

### SUMMARY

According to an embodiment, a first responder system is provided including an emergency control decision system configured to communicate with one or more systems of a building during an emergency event. The emergency control decision system includes at least one module configured to determine one or more alternative uses of resources available within the building. The emergency control decision system also includes a decision management module configured to process data collected from the building and the at least one module. An interactive first responder interface is operably coupled to the decision management module and is configured to present relevant information to emergency personnel.

In addition to one or more of the features described above, or as an alternative, in further embodiments the emergency control decision system is configured to communicate with at least one sensor within the building.

In addition to one or more of the features described above, or as an alternative, in further embodiments the emergency control decision system is configured to communicate with and control at least one piece of building equipment.

In addition to one or more of the features described above, or as an alternative, in further embodiments the first responder interface is configured to present information regarding a present status of the building in real-time.

In addition to one or more of the features described above, or as an alternative, in further embodiments the decision management module is configured to process data to generate at least one of a threat mitigation strategy and an evacuation strategy.

In addition to one or more of the features described above, or as an alternative, in further embodiments through the first responder interface, the at least one of a threat mitigation strategy and an evacuation strategy includes a prioritized list of recommended actions to address the emergency event.

In addition to one or more of the features described above, or as an alternative, in further embodiments the at least one of a threat mitigation strategy and an evacuation strategy includes one or more prioritized recommended actions arranged into groups to provide various strategies. The recommended actions within each group have at least one distinct parameter.

In addition to one or more of the features described above, or as an alternative, in further embodiments one or more recommended actions that can be selected by emergency personnel are updated in real time.

In addition to one or more of the features described above, or as an alternative, in further embodiments the first responder interface is configured to allow emergency personnel to select a portion or all of the recommended actions of a group.

In addition to one or more of the features described above, or as an alternative, in further embodiments the first responder interface is configured to allow emergency personnel to modify one or more of the recommended actions.

In addition to one or more of the features described above, or as an alternative, in further embodiments the first responder interface is configured to allow emergency personnel to select one or more recommended actions from a plurality of the groups.

In addition to one or more of the features described above, or as an alternative, in further embodiments the first responder interface is configured to allow emergency personnel to reject all of the recommended actions and create a responder-defined action.

According to an embodiment, a method of operating a first responder system is provided including receiving data from at least one of a building sensor and building equipment. At least one of a threat mitigation strategy and an evacuation strategy includes a list of prioritized recommended actions. At least one of a threat mitigation strategy or an evacuation strategy is presented to emergency personnel via a first responder interface.

In addition to one or more of the features described above, or as an alternative, in further embodiments the method additionally includes selecting at least one recommended action from the list of prioritized recommended actions and implementing the at least one recommended action selected.

In addition to one or more of the features described above, or as an alternative, in further embodiments implementing the at least one recommended action selected occurs in real-time.

In addition to one or more of the features described above, or as an alternative, in further embodiments the method additionally includes rejecting all of the recommended actions. At least one responder-defined action is created. The at least one responder-defined action is implemented.

In addition to one or more of the features described above, or as an alternative, in further embodiments the first responder interface is accessible via plurality of devices including mobile device.

In addition to one or more of the features described above, or as an alternative, in further embodiments the first responder interface includes a distributed interface.

### BRIEF DESCRIPTION OF THE DRAWINGS

The subject matter, which is regarded as the present disclosure, is particularly pointed out and distinctly claimed at the conclusion of the specification. The foregoing and other features and advantages of the present disclosure are apparent from the following detailed description, taken in conjunction with the accompanying drawings, in which:

FIG. 1 is a perspective view of an example of an building including a building event management system according to an embodiment of the present disclosure;

FIG. 2 is a schematic diagram of a first responder system operably coupled to the building event management system according to an embodiment of the present disclosure;

FIG. 3 is a schematic diagram of an emergency control decision system of the first responder system according to an embodiment of the present disclosure;

FIG. 4 is an example of a main screen of a first responder interface of the first responder system according to an embodiment of the present disclosure; and

FIG. 5 is an example of an evacuation strategy presented via a first responder interface including a prioritized list of recommended actions according to an embodiment of the present disclosure.

The detailed description of the present disclosure describes exemplary embodiments of the present disclosure, together with some of the advantages and features thereof, by way of example with reference to the drawings.

### DETAILED DESCRIPTION

The system and method disclosed herein provides for automatically generating a real-time emergency action plan or interactive rescue plan accessible by first responders and site managers. The real-time action plan or interactive rescue plan may provide a first responder with interactive site and surrounding information necessary for efficiently deploying resources to address an emergency. The real-time emergency action plan or interactive rescue plan may include detailed information about the building or the emergency event, such as building information, real-time traffic information, and alarm and sensor information.

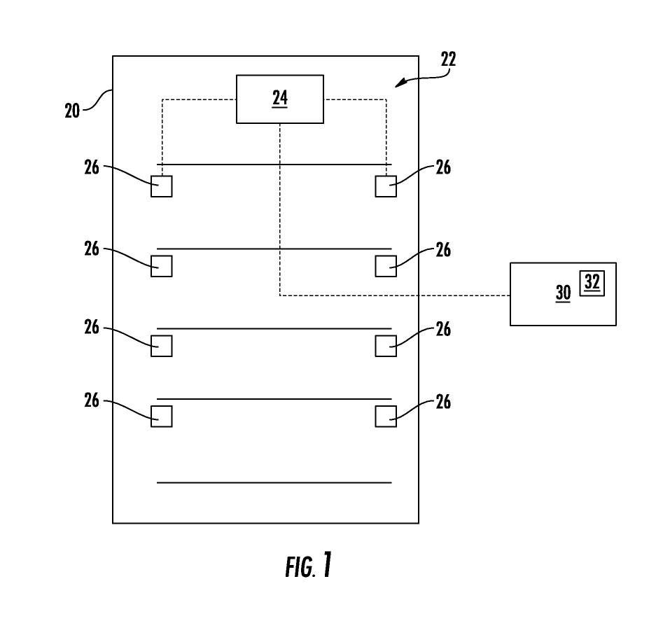

Referring now to the FIG. 1, an example of a building 20 including a building event management system 22 is illustrated in more detail. The building event management system 22 is configured to continuously monitor a status of a building 20. It should be understood that the term building as used herein may include a plurality of interconnected or separate structures or buildings located at one or more known geographical locations. The building event management system 22 includes a controller 24 configured to receive real-time information from a plurality of hard-wired or wireless sensors 26 disposed throughout the building 20. The sensors 26 may be temperature sensors, fire sensors, alarm pull stations, carbon monoxide sensors, door sensors, chemical sensors, motion and light sensors, or any other building automation devices, components or sensors. Alternatively, or in addition, the controller 24 may be configured to gather information either actively or passively from the mobile devices carried by the building occupants, such as a cell phone, personal digital assistant, tablet, or RFID card for example.

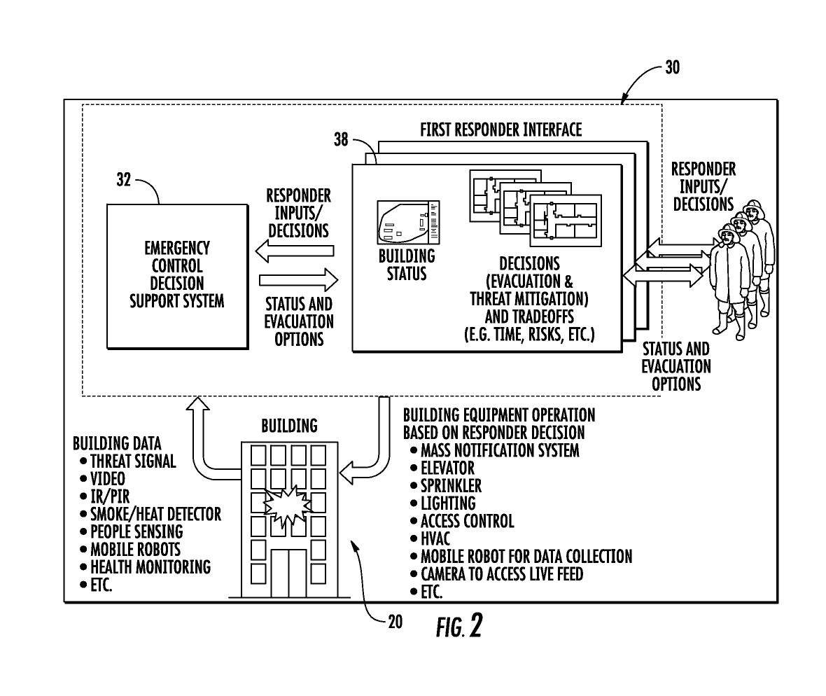

Referring now to FIG. 2, a first responder system 30 is operably coupled to and configured to communicate with a building event management system 22, and more specifically the controller 24 thereof, through any type of communication network, including but not limited to, a cellular network, the internet, a wide area network, a virtual private network, a wireless network, or any combination thereof for example. The first responder system 30 may additionally be arranged in communication with any other system configured to assist in data collection or help control operation of equipment within the building 20. The first responder system 30 includes an emergency control decision system 32 configured to process the data from the various sensors 26 and communicate with various building equipment and systems.

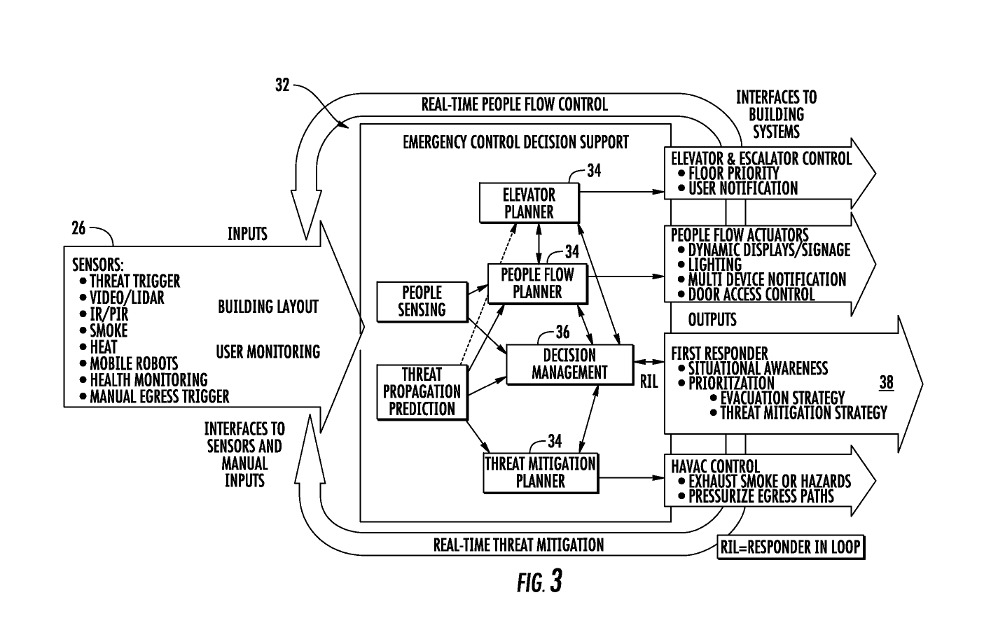

In one embodiment, as shown in FIG. 3, the emergency control decision system 32 includes a plurality of modules 34, such as a people flow planner module and an elevator planner module for example, for evaluating the best use of the resources available in the building 20. In addition, a threat mitigation planner module 34 may identify strategies for threat elimination and/or strategies for slowing propagation of the threat. A decision management module 36 is configured to collect the data from the sensors 26, and from each of the plurality of other modules 34 and present information to a user, including but not limited to first responders and emergency personnel for example, through a first responder interface 38 configured to present relevant data in a clear and organized manner. The emergency control decision system 32 may be positioned locally or remotely, relative to both the building 20 and an interface 38 for accessing the first responder system 30.

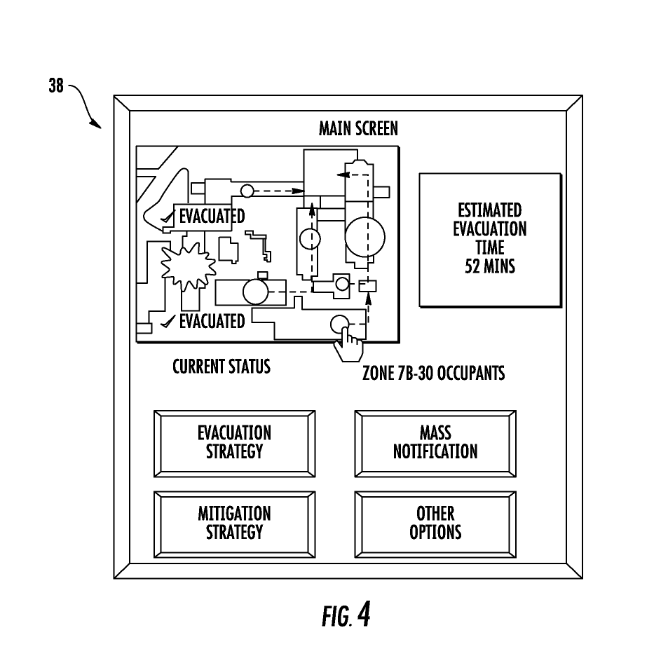

An example of a screen shot of the main screen of the first responder interface 38 is illustrated in FIG. 4. In the illustrated, non-limiting embodiment, the first responder interface 38 provides situational awareness to a user thereof, such as through an overall building map, information regarding the emergency event, estimated occupant distribution throughout the building, estimated evacuation time, and other important information. The main screen may additionally allow emergency personnel to navigate between various strategies recommended by the decision management module 36.

The first responder interface 38 is configured to allow the responder to interact therewith, for example zoom in, interrogate more detailed reports, or select one or more buttons or entries presented thereon. In one embodiment, through the user interface 38, the first responder system 30 is configured to provide emergency personnel with information about the present building status in real-time. For example, the first responder system 30 may display an operational status of specific equipment within the building 20, such as elevators, water pumps, or a heating ventilation and air conditioning (HVAC) system. When displaying information regarding the equipment within the building 20, the first responder system 30 may allow emergency personnel to adjust the operating parameters or shutoff any of the equipment. The first responder system 30 may additionally display the measurements or data from one or more of the sensors 26 arranged throughout the budding 20. In one embodiment, the interface 38 of the first responder system 30 is configured to display a status for only a portion of the building 20, such as a zone for example. The status may include information such as expected evacuation time, sensor status, egress path status and inputs manually entered by emergency personal such as whether or not that portion of the building 20 has been “cleared.” However, it should be understood that the display of any information that may be considered useful to emergency personnel is within the scope of the present disclosure.

Alternatively or in addition, the first responder system 30, through the first responder interface 38, may be configured to provide emergency personnel with a prioritized list of recommended actions to address an emergency event within a building. In one embodiment, the decision management module 36 processes the data received to generate a list of recommend actions, and a specific order for implementing those actions, to minimize the danger to the building occupants (mitigation strategy) and/or increase the efficiency of the building evacuation if necessary (evacuation strategy).

In addition, the first responder system 30 may be configured to present the relative merits of each option presented, such as the level of risk involved and the total evacuation time for example. Examples of the actions identified by the emergency control decision module 32 include floor evacuation priority, stair vs. elevator evacuation for each floor, and the number of elevators serving each designated floor for example. The emergency control decision module 32 may also be configured to perform other actions such as notify the building occupants of the modified evacuation plan, control the HVAC system and lighting for the evacuation path, and override restricted access to one or more of the elevators.

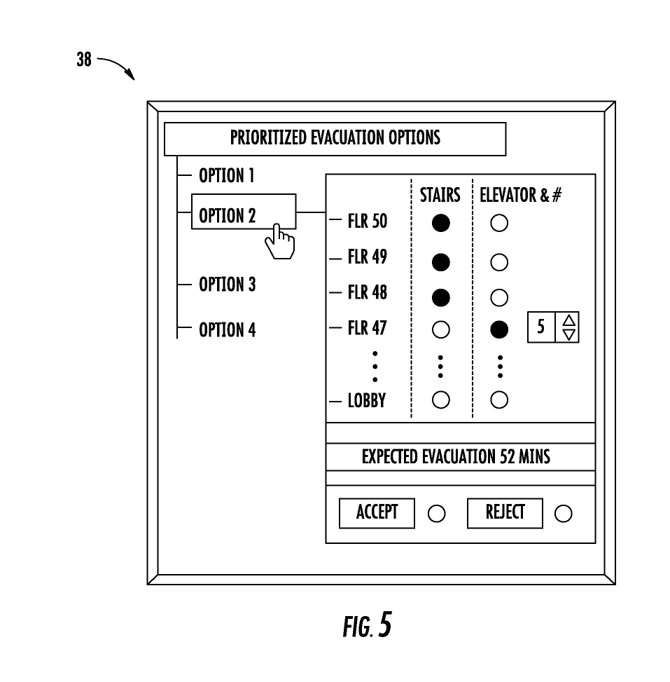

In the illustrated, non-limiting embodiment of FIG. 5, the recommended actions presented via the first responder interface 38 are arranged into groups, each group consisting of one or more recommended actions. The recommended actions within each group may be the similar or different, and based on the order presented may have one or more unique parameters. Emergency personnel when reviewing the recommended actions or groups thereof presented via the interface 38 may select one or more of the recommended actions, or only a subset of the recommended actions. Alternatively or in addition, emergency personnel may make modifications to or mix and match actions from each of the groups. In yet another embodiment, emergency personnel may reject all of the recommended actions and create a responder-defined action. The emergency responder system 30 may require confirmation of one or more parameters of the responder-defined action before communicating the action to the emergency control decision module 32 and updating the system 30 accordingly.

In all embodiments, the selections made by emergency personnel including modifications, cancellations, and changes to the selected actions will be updated in real time. In addition, as the sensed conditions within the building 20 change, the first responder system 30 may be configured to provide an updated list of recommended actions or groups of recommended actions to provide an enhanced threat mitigation and evacuation strategy. Once a strategy including one or more actions has been selected, the emergency control system 32 will implement those selections via its interface 38 with the building event management system 22. For example, the first responder system 30 will communicate with one or more actuators connected to the specific equipment within the building 20 to implement the selected recommended actions. Commands generated by the first responder system 30 will have the authority to override default operation of the building equipment during an emergency event.

When the building event management system 22 detects an emergency event, such as a fire for example, the building event management system 22 generates an alarm which is communicated to the first responder system 30. A person at the building 20 may prompt the building event management system 22 to send the alert, or alternatively, the building event management system 22 may generate the signal automatically based on the information collected by the plurality of sensors 26. The first responder system 30 may be accessible on one or more devices arranged either locally at the building 20 or remotely, such as at an emergency responder location like a fire station for example. In addition, the one or more devices may be stationary workstations, or alternatively, may be mobile devices, such as a tablet, laptop, smartphone or similar device. In one embodiment, the status information provided by the building event management system 22 and the recommended actions generated by the first responder system 30 may be hosted on a server accessible by the at least one device.

The first responder system 30 may be operated as a central interface or a distributed interface. In instances where the first responder system 30 includes a distributed implementation, the interface 38 will inform the responder about actions implemented by other emergency personnel, and any potential conflicts. The distributed interfaces may be formed having a hierarchy of authority, thereby allowing certain emergency personnel to override recommended actions selected by emergency personnel having a lower level of authority. For example, a responder at the scene of the emergency event may be configured to override the actions selected by a person located remotely. In addition, the distributed interface may allow real-time communication, such as voice or video communication for example, between two or more devices connected to the first responder system 30.

The first responder system 30 and interface 38 as described herein will provide emergency personnel with clear information regarding an emergency event, thereby reducing the learning time to achieve situational awareness for first responders. Presentation of prioritized recommend actions for threat mitigation and/or evacuation allows for quick implementation of selected actions. In addition, the first responder system allows for continuous monitoring of an emergency event and provides updates to the strategy in real-time allowing for rapid changes if necessary.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, or equivalent arrangements not heretofore described but which are commensurate with the spirit and scope of the present disclosure. Additionally, while various embodiments of the present disclosure have been described, it is to be understood that aspects of the present disclosure may include only some of the described embodiments. Accordingly, the present disclosure n is not to be seen as limited by the foregoing description, but is only limited by the scope of the appended claims.

1. A first responder system, comprising:
an emergency control decision system configured to communicate with and control one or more systems of a building or one or more pieces of building equipment during an emergency event, the emergency control decision system including:
at least one module configured to determine one or more alternative uses of resources available within the building; and
a decision management module configured to process data collected from the building and the at least one module; and
an interactive first responder interface operably coupled to the decision management module and configured to present relevant information to emergency personnel.

2. The first responder system according to claim 1, wherein the emergency control decision system is configured to communicate with at least one sensor within the building.

3. (canceled)

4. The first responder system according to claim 1, wherein the first responder interface is configured to present information regarding a present status of the building in real-time.

5. The first responder system according to claim 1, wherein the decision management module is configured to process data to generate at least one of a threat mitigation strategy and an evacuation strategy.

6. The first responder system according to claim 5, wherein through the first responder interface, the at least one of a threat mitigation strategy and an evacuation strategy includes a prioritized list of recommended actions to address the emergency event.

7. The first responder system according to claim 6, wherein the at least one of a threat mitigation strategy and an evacuation strategy includes one or more prioritized recommended actions arranged into groups to provide various strategies, the recommended actions within each group having at least one distinct parameter.

8. The first responder system according to claim 7, wherein one or more recommended actions that can be selected by emergency personnel are updated in real time.

9. The first responder system according to claim 8, wherein the first responder interface is configured to allow emergency personnel to select a portion or all of the recommended actions of a group.

10. The first responder system according to claim 8, wherein the first responder interface is configured to allow emergency personnel to modify one or more of the recommended actions.

11. The first responder system according to claim 8, wherein the first responder interface is configured to allow emergency personnel to select one or more recommended actions from a plurality of the groups.

12. The first responder system according to claim 8, wherein the first responder interface is configured to allow emergency personnel to reject all of the recommended actions and create a responder-defined action.

13. A method of operating a first responder system:
receiving data from at least one of a building sensor and building equipment;
generating at least one of a threat mitigation strategy and an evacuation strategy including a list of prioritized recommended actions; and
presenting at least one of a threat mitigation strategy or an evacuation strategy to emergency personnel via a first responder interface.

14. The method according to claim 13, further comprising:
selecting at least one recommended action from the list of prioritized recommended actions; and
implementing the at least one recommended action selected.

15. The method according to claim 14, wherein implementing the at least one recommended action selected occurs in real-time.

16. The method according to claim 13, further comprising:
rejecting all of the recommended actions;
creating at least one responder-defined action; and
implementing the at least one responder-defined action.

17. The method according to claim 13, wherein the first responder interface is accessible via plurality of devices including mobile device.

18. The method according to claim 13, wherein the first responder interface includes a distributed interface.
